(19) United States
(12) Patent Application Publication
(10) Pub. No.: US 2020/0123849 A1
(43) Pub. Date: Apr. 23, 2020

(54) WINDING APPARATUS FOR ROLLER BLINDS

(71) Applicant: Emil Feder, Kassel (DE)

(72) Inventors: Emil Feder, Kassel (DE); Martha Lucia Castro Ortiz, Bogota (CO)

(21) Appl. No.: 16/722,314

(22) Filed: Dec. 20, 2019

Related U.S. Application Data
(63) Continuation of application No. PCT/DE2018/100596, filed on Jun. 28, 2018.

(30) Foreign Application Priority Data
Jun. 28, 2017 (DE) 10 2017 114 406.4

(51) Int. Cl. E06B 9/44; A47H 1/13; E06B 9/68

(52) U.S. Cl. CPC E06B 9/44; E06B 2009/425; E06B 9/68; A47H 1/13

(57) ABSTRACT

A winding apparatus for roller blinds (1) includes a winding roll (3) which supports a hanging (2) such that it is windable on and unwindable from the winding roll (3) by an actuator (9). The actuator (9) includes two steps of actuation. In a first step, actuation of the actuator (9) causes winding up and unwinding of the hanging (2). In a second step, actuation of the actuator (9) causes a gap existing between the hanging and the mounting location of the winding apparatus (1) to be decreased and increased, respectively.

### CROSS REFERENCE TO RELATED APPLICATIONS

This application is a continuation of International Application PCT/DE2018/100596 with an international filing date of Jun. 28, 2018 and claiming priority to German Patent No. DE 10 2017 114 406.4 entitled “Verdunklungsvorrichtung”, filed on Jun. 28, 2017.

### FIELD OF THE INVENTION

The invention relates to a winding apparatus for roller blinds. Such winding apparatus are usually mounted at a door, a window, a door frame, a window frame or a wall by mounting elements—called wall brackets in the following—by screws, gluing, clamping and so forth.

Such winding apparatus for roller blinds are known in many ways, and they include a winding roll carrying a hanging that is windable and unwindable. The winding roll is arranged between a left winding roll bracket and a right winding roll bracket at these winding roll brackets in a rotatingly fixed manner. The winding roll brackets include elements, for example pins or supporting arms, which are—directly or indirectly—rotatingly supported in wall brackets.

A drive element is arranged at one of the winding roll brackets in a rotatingly fixed manner, the drive element being drivable by an actuator. In this way, the winding roll can be rotated by the actuator and the hanging on the winding roll can be wound up and unwound. Such winding apparatus are often designed as roller blinds including a chain wheel drive by which the hanging is wound up and unwound.

### BACKGROUND OF THE INVENTION

A winding apparatus for roller blinds is known from document DE 714 166 A which proposes to support the winding roll in a support slot of a supporting arm. The support slot is angled, opened in an upward direction and extends transversely in a downward direction against the window. This results in there substantially being no gap when winding up and unwinding the hanging of the winding roll. However, it has to be accepted that the hanging continuously rubs at the window and at the wall, respectively, during winding and unwinding. Consequently, in the long run, the window and the wall, respectively, as well as the hanging are damaged. This may not only result in visible damages of the window and the wall, respectively, as well as of the hanging. This may rather lead to malfunction of the darkening apparatus during winding and unwinding of the hanging on the winding roll. In the worst case, this may lead to the darkening apparatus no longer being operable such that it has to be replaced.

Another winding apparatus for roller blinds is known from document DE 20 2008 010 876 U1. It is intended to prevent a gap between the hanging and the mounting location of the winding apparatus. For this purpose, a guiding bar for the hanging is arranged at the bottom side of the winding apparatus, the guiding bar being arranged close to the surface of the mounting location. When winding and unwinding the hanging, the hanging is guided by the guiding bar. It is intended to prevent a gap through which light can pass. However, the above described problems concerning possible damages also occur in this winding apparatus. This may lead to malfunctions which, in the worst case, make it necessary to replace the winding apparatus.

Furthermore, to prevent an incidence of light, it is generally known in the art to guide the hanging by U-shaped profiles being arranged at the wall and serving to prevent a gap from being formed. However, this also results in frictional contact which can damage the hanging. Furthermore, when using such U-shaped profiles, an incidence of light above the U-shaped profiles is not prevented since the gap there cannot be fully closed by the U-shaped profiles. Instead, a gap through which an incidence of light occurs remains between the winding roll and the wall.

Winding apparatus for roller blinds are also known from documents DE 27 54 521 A1, WO 20151012624 A1 and U.S. Pat. No. 4,846,241.

### SUMMARY OF THE INVENTION

The present invention relates to a winding apparatus for roller blinds. The winding apparatus includes a left winding roll bracket, a right winding roll bracket and a winding roll. The winding roll supports a hanging such that it is windable on and unwindable from the winding roll. The winding roll is arranged between the left winding roll bracket and the right winding roll bracket, and it is connected to the left winding roll bracket and the right winding roll bracket to be commonly rotated with the left winding roll bracket and the right winding roll. The winding apparatus also includes an actuator and a drive element. The drive element is connected to one of the winding roll brackets to be commonly rotated with the left winding roll bracket and the right winding roll. The drive element is designed and arranged to be driven by the actuator such that the winding roll is rotated and the hanging is wound up on and unwound from the winding roll. The winding apparatus also includes a plurality of intermediate elements and a plurality of moving units. The moving units are arranged between the left winding roll bracket and the right winding roll bracket, and they are connected to the intermediate elements. The moving units are designed and arranged to support the winding roll. The moving units are designed and arranged to move the winding roll, the left winding roll bracket, the right winding roll bracket and the hanging between a rotational position and a holding position due to an actuation of the actuator.

The present invention also relates to a winding apparatus for roller blinds including a winding roll which supports a hanging such that it is windable on and unwindable from the winding roll by an actuator. The actuator includes two steps of actuation. In a first step, actuation of the actuator causes winding up and unwinding of the hanging. In a second step, actuation of the actuator causes a gap existing between the hanging and the mounting location of the winding apparatus to be decreased and increased, respectively.

In this application, a wall bracket is not only to be understood as a bracket or holder for attachment to a wall—for example by screws, gluing or clamping —, but also for direct attachment to windows, doors, door frames and window frames. In these cases, the frame of the window and of the door, respectively, is to be understood as the wall in the sense of the invention. The term “wall bracket” is only used for reasons of simplicity, and it is not intended to contain any limitation in the sense of only referring to a wall or how the bracket is fixed.

Generally, it is to be considered that such wall brackets usually are designed as wall brackets and ceiling brackets, respectively, by which a direct attachment of the winding apparatus at walls and at ceilings, respectively, and also at door frames and window frames is made possible.

The door, the window, the door frame, the window frame or the wall to which the winding apparatus is mounted is partly abbreviated as mounting location in this application.

The winding apparatus may be designed as darkening apparatus or as insect protection apparatus. In a darkening apparatus, the hanging is designed to be lightproof, while in an insect protection apparatus, the hanging is designed as a fine mesh allowing for passage of light and air, but not for a passage of insects.

In the prior art, there is the problem with winding apparatus that the winding roll usually is arranged and attached, respectively, at a fixed distance to mounting location. The distance between the hanging of the winding apparatus and the mounting location is the smallest when the hanging is fully wound up on the winding roll and the mounting location is not covered.

In the prior art, this problem has been often addressed, but no satisfying solution has been offered since possible diminishing or preventing such a gap and the incidence of light and the free space, respectively, resulted in disadvantages for the consumer which are not acceptable.

When the hanging is now unwound from the winding roll to cover the mounting location, the gap between the mounting location and the hanging is increased due to the diameter decreasing. Thus, when the mounting location is fully covered by such a winding apparatus, the gap reaches its maximum just when this is least desired. Consequently, there is the greatest incidence of light passing through this gap and the greatest free space, respectively, just when it is desired to fully cover the window and the door, respectively. This applies to the use of the winding apparatus as a darkening apparatus as well as as an insect protection apparatus.

The new winding apparatus for roller blinds allows for effective and complete darkening of the mounting location without damaging the apparatus itself, the hanging or mounting location, while providing simple and secure functionality with only a few operating elements.

The new winding apparatus for roller blinds includes a winding roll carrying a hanging that is windable and unwindable. The winding roll is arranged between a left winding roll bracket and a right winding roll bracket at these winding roll brackets in a rotatingly fixed manner. A drive element is arranged at one of the winding roll brackets in a rotatingly fixed manner, the drive element being drivable by an actuator. In this way, the winding roll can be rotated by the actuator and the hanging on the winding roll can be wound up and unwound.

The winding roll brackets are not directly supported in the wall brackets by pins, supporting arms and the like. Instead, moving units are arranged on intermediate elements between the winding roll brackets and the wall brackets. The moving units support the winding roll brackets and move, by an actuator, the winding roll including the winding roll brackets and the hanging from a rotational position into an effective and/or holding position and back when the hanging is unwound as desired, the winding roll brackets being rotatably supported in the moving units.

Due to the new winding apparatus, it is possible that the hanging of the winding apparatus for roller blinds for covering mounting location is first unwound by the actuator until the hanging fully covers the mounting location, while there always is a gap between the mounting location and the hanging. This gap prevents complete coverage. However, when the actuator of the new winding apparatus is further actuated, this gap is closed by moving the entire winding roll including the hanging and the winding roll brackets towards the mounting location by the moving units between the winding roll brackets and the intermediate elements. This movement is continued until the hanging gets in contact and this gap is closed. In this way, complete and effective coverage without a gap is possible without requiring additional elements for minimizing and closing, respectively, the gap.

The entire actuation mechanism is thus realized by an actuator in two steps. In the first step, covering the window and the door, respectively, is realized. In the second step, the gap is closed. Since the hanging is free from contact to other elements when it is unwound, neither the hanging nor another element can be damaged by this unwinding movement. Consequently, there is no damaging of the winding apparatus due to the unwinding movement which could cause the necessity of having to replace the winding apparatus.

In the same way as covering is realized in two steps, canceling the coverage is also realized in two steps. To cancel coverage, in a first step, for example, the actuator is actuated to wind up the hanging on the winding roll. However, for winding up of the hanging on the winding roll begins, the gap is reopened by the entire winding roll including the hanging and the winding roll brackets being moved in a direction away from the door or the window by the moving units between the winding roll brackets and the wall brackets. When further actuating the actuator, the hanging is now wound up on the winding roll without contacting other elements.

Thus, the new winding apparatus allows for secure coverage of windows and doors without the hanging contacting other elements when being wound up and unwound. In this way, damages of the hanging and of other elements and malfunction of the winding apparatus caused thereby are effectively prevented. In addition, the new winding apparatus includes a multifunctional actuator allowing for winding and unwinding of the hanging on the winding roll as well as closing and opening of the gap between the hanging and the mounting location.

However, it is possible that, due to unevenness of the wall and of the contact surface of the hanging, respectively, a small gap remains through which some life and/or air can enter. Thus, in an embodiment of the winding apparatus, the hanging may be provided with a structure at its lateral end portions, the structure cooperating with a counter structure being arranged at the wall and at the contact surface, respectively, such that the remaining gap is closed. For example, such structures and counter structures may be Velcro fasteners including a hook structure and a loop structure.

However, according to another aspect—to prevent thickening of the hanging—the cooperating structure at the side of the hanging is arranged laterally at the hanging by suitable measures, for example melting or gluing of the edges, such that one attains a smooth plane.

However, it is also imaginable to use electrostatically or electromagnetically cooperating structures and counter structures for this purpose. One of the structures is electrostatically charged and electrically actuated, respectively, such that there is attraction between the structures and the counter structures resulting in the gap being closed.

Generally, the new actuators are to be understood as manually drivable actuators and drives as well as actuators being drivable by a motor, especially an electric motor.

According to another embodiment of the apparatus, the wall brackets and the intermediate elements may be designed as one piece or as a plurality of pieces.

It is possible that the moving units move the winding roll into the respective position by rolling, sliding, swinging or rocking.

According to another embodiment of the apparatus, the two moving units are interconnected by a torque transmission element in a rotatingly fixed manner. Thereby, it is ensured that the movement applied by the actuator onto one of the moving units is also transmitted to the other moving unit without loading the winding roll. The torque transmission element may be designed as a pin or a tube, especially a square tube, and especially extends through the winding roll being designed as a hollow roll and the winding roll brackets being designed as hollow pins. The hollow pins carry the winding roll and serve as a hub being rotatingly supported on the transmission elements of the moving units being designed as an axle. The winding roll may be subjected to a spring tension. A respective spring may be arranged between the torque transmission element and the winding roll. The spring is connected to the torque transmission element, on the one hand, and to the winding roll, on the other hand.

It is also possible to arrange such a torque transmission element outside of the winding roll and parallel to the winding roll, i.e. such that it does not extend through the winding roll. For example, the winding roll may be moved from a rotational position to a holding position by a rocker being supported in the intermediate elements. The hanging of the winding apparatus may be actuated by a known center pull, while the rocker is actuated by its own actuator.

A further embodiment of the torque transmission element is suggested when using a drive including an electric motor. The torque transmission elements extends through the winding roll and through a drive including an electric motor, for example a respective tube motor. By suitable control measures, after having reached the desired holding position, the torque transmission elements is actuated by respective actuators and fulfills the desired movement resulting in the gap being closed. It is also possible that elements of the drive including an electric motor are used as the torque transmission element.

According to another aspect of the invention, the two moving units include transmission elements which

a) at one of their ends include a pin connecting the moving units to the torque transmission element in a rotatingly fixed manner,

b) in their middle portion include supports for the winding roll brackets, the winding roll brackets being rotatably supported on the supports, and

c) at their other end include elements for realizing the transfer of the winding roll including the winding roll brackets and the hanging from a rotational position into an effective and holding position, the elements cooperating with counter elements being arranged at the intermediate elements.

By this embodiment, it is ensured that the winding roll is rotatingly supported on the transmission element of the moving units in a simple matter for winding and unwinding the hanging, while, at the same time, the two transmission elements are interconnected by the torque transmission element in a rotatingly fixed manner. At the same time, elements are arranged at the transmission elements which, in cooperation with respective counter elements of the wall brackets, allow for moving the winding roll within the wall brackets.

The drive element may cooperate with a blocking element being arranged on the transmission element such that a blocking element being arranged on the actuator blocks rotation of the winding roll when the blocking element is reached. When the actuator is further actuated, transfer of the winding roll including the winding roll brackets and the hanging from a rotational position into a darkening position is caused by the moving units. In this way, the multi-functionality of the actuator is realized in a simple way such that, for causing winding and unwinding of the hanging and for moving the moving units, it is sufficient to only use one actuator.

The drive element may be designed as a ball wheel and as a ball gear wheel, respectively, and the actuator may be designed as a ball chain. The blocking element may be designed as a cover for the ball wheel which includes a passage opening for the balls of the ball chain. The locking element may be designed as a ball element including two shells that are clipped together. The locking element may be arrangeable on one of the balls of the ball chain, and it may have a diameter which is greater than the passage opening of the cover. By this design, it is possible to use the ball wheel drives known from winding apparatus. This makes it possible to realize the multi-functionality of the actuator without having to fully develop a new drive system, i.e. to use synergetic effects.

The cover may include a resilient leg and a protrusion facing towards the wall bracket, the protrusion engaging into a counter protrusion of the wall bracket in a way that, when the hanging is wound up and unwound by the actuator, an actuation of the moving units is stopped and blocked, respectively, while the ball element including two shells and being arranged on the ball chain, when it reaches the passage opening for the balls off the ball chain and when the ball chain is further actuated, cancels this prevention and blockage, respectively, of the moving units since the spring-biased leg is loaded and the protrusion gets free from engagement with the counter protrusion thereby. In this way, it is ensured that the moving units are not moved when the hanging is wound up or unwound. Only after the protrusion and the counter protrusion do no longer engage, it is possible to actuate the moving units by the ball chain. In the same way, actuation of the ball wheel is only possible when the protrusion and the counter protrusion engage.

According to another embodiment of the winding apparatus, the moving units include elements being designed as dancer arms and supports for counter elements of the intermediate elements on which they are pivotally supported between a first stop and a second stop of the intermediate elements. The supports of the dancer arms may be designed as bolt supports at the counter elements are designed as bolts. A support is provided at the ends of the dancer arms opposite to the bolt supports, the dancer arms being arranged by the support at the transmission elements in a rotatingly fixed manner. Due to this design, the hanging on the winding roll can be wound up and unwound as long as the dancer arms contact the respective first stop. When moving the moving units, the dancer arms are pivoted until the hanging contacts the door, the window, the door frame or the window frame and the wall, respectively, or the dancer arms contact the respective second stop and prevent continuation of the winding movement.

It is also possible that the elements are designed as gear wheels or pitch circle of a gear wheel which cooperate with counter elements of the intermediate elements being designed as gear racks on which they can be moved between two end positions.

way, it is not necessary to use different parts for manufacturing the ball element including two shells which results in minimizing the manufacturing and tooling costs as well as the logistic expenditure. It has been found to be positive to design the identical shells of the ball element as hemispheres each including a slot extending to the center of the hemispheres. Opposite to the slot, they include a ball segment. The slots and the ball segments cooperate such that, in the clipped together condition of the identical shells, a ball of the ball chain is held in the ball element. The string or cord connecting the balls off the ball chain extends into the ball element and out off the ball element. The two hemispheres may be divided longitudinally or transversely to the direction of the spring or cord.

It is also possible to use hemispheres not including slots and only including openings for the string or cord of the ball chain. They can be unclipped longitudinally to the string or cord of the ball chain.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 illustrates a first exemplary embodiment of a new winding apparatus for roller blinds in a perspective view.

FIG. 2 illustrates the winding apparatus for roller blinds of FIG. 1 in another perspective view.

FIG. 3 illustrates the winding apparatus for roller blinds of FIG. 1 in an exploded view.

FIG. 4 illustrates the winding apparatus for roller blinds of FIG. 2 in an exploded view.

FIG. 5 illustrates a second exemplary embodiment of the new winding apparatus for roller blinds in a perspective view.

FIG. 6 illustrates the winding apparatus for roller blinds of FIG. 5 in another perspective view.

FIG. 7 illustrates the winding apparatus for roller blinds of FIG. 5 in an exploded view.

FIG. 8 illustrates the winding apparatus for roller blinds of FIG. 6 in an exploded view.

### DETAILED DESCRIPTION

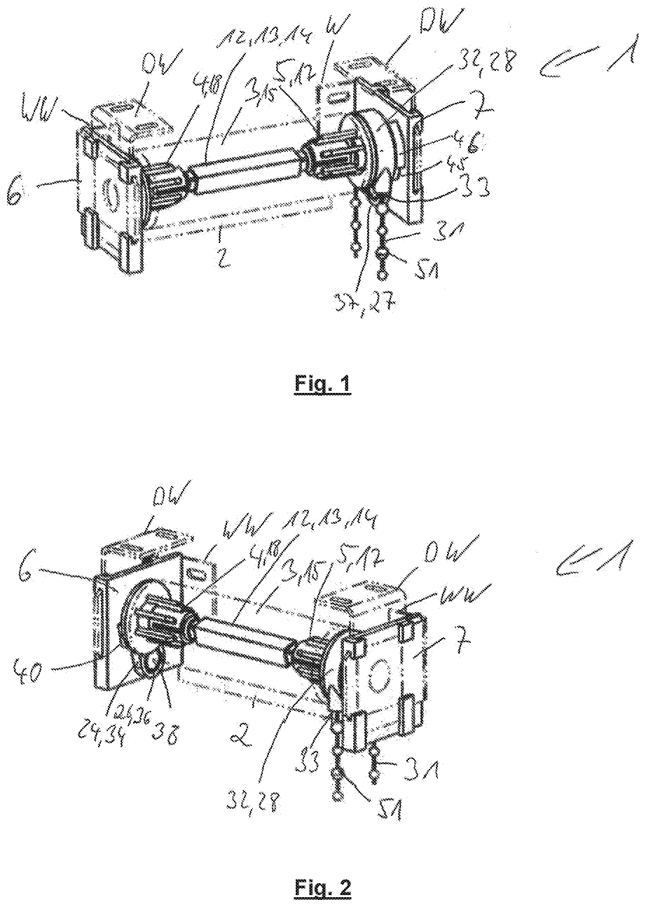

FIGS. 1 and 2 illustrate different perspectives of a first exemplary embodiment of a new winding apparatus 1. A winding roll 3 carrying a hanging 2 as well as different wall brackets WW and ceiling brackets DW are only schematically illustrated. Intermediate elements 6 and 7 can be arranged at the wall brackets WW and the ceiling brackets DW to enable the winding apparatus 1 to be connected to a non-illustrated wall, ceiling or door and a non-illustrated window, window frame or door frame, respectively, also being designated as “mounting location” hereinafter.

These illustrations do not show all details of the new mechanism. However, it is to be seen that winding roll brackets 4 and 5 are arranged at the intermediate elements 6 and 7. The winding roll brackets 4 and 5 are designed as hollow pins 16 and 17 at which the winding roll 3 being designed as a hollow roll 15 is located in a rotatingly fixed manner. The winding roll brackets 4 and 5 are supported on transmission elements 22 and 23 in a rotatingly fixed manner. The transmission elements 22 and 23 are interconnected in a rotatingly fixed manner by a torque transmission element 12 being designed as a tube 13 and a square tube 14, respectively.

Furthermore, an element 24 being designed as a dancer arm 34 is to be seen in FIG. 2 which is pivotally supported by a bolt support 36 on a bolt 38 of the intermediate elements 6. Furthermore, a stop 40 for the intermediate elements 6 is to be seen which is contacted by the dancer arm 34.

FIG. 1 illustrates a blocking element 28 being designed as a cover 32 for a ball wheel 30 which is not visible. The cover 32 includes passage openings 33 through which an actuator 9, which is designed as a ball chain 31, for a drive element being designed as the ball wheel 30 can be moved. A ball element 51 is arranged on the ball chain 31, the ball element 51 being bigger than the other balls of the ball chain 31 and not being able to pass the passage opening 33. The cover 32 includes a resilient leg 44 which is not visible and at which a protrusion 45 is arranged, the protrusion 45 cooperating with a counter protrusion 46 of the intermediate elements.

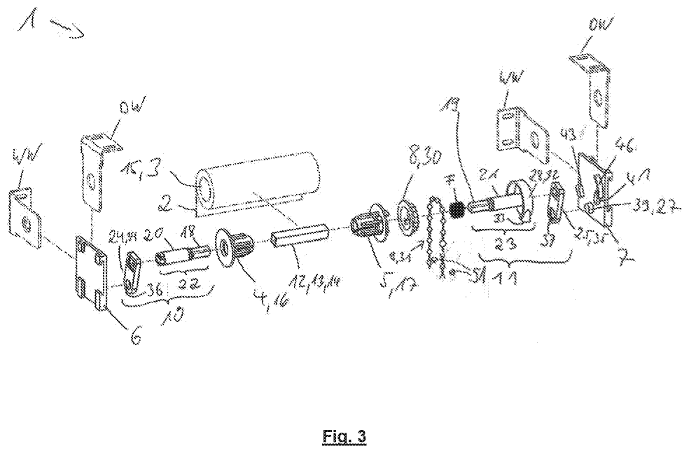

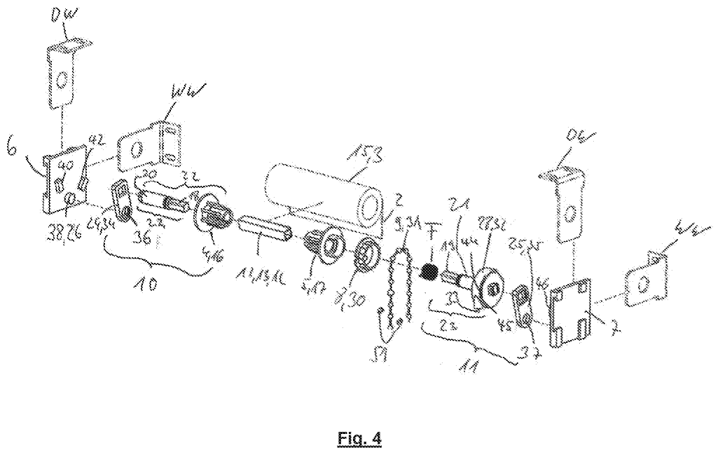

FIGS. 3 and 4 illustrate two different exploded views of the winding apparatus 1 of FIGS. 1 and 2 from which the functionality of the exemplary embodiment can be understood. Two moving units 10 and 11 are well recognizable. The function of moving the winding roll 3 towards a mounting location is integrated in the moving units 10 and 11. The winding roll 3 is arranged on the winding roll brackets 4 and 5 being designed as hollow pins 16 and 17 in a rotatingly fixed manner. A ball wheel 30 is arranged on the winding roll bracket 5 in a rotatingly fixed manner such that the winding roll 3 can be rotated by a ball chain 31 cooperating with the ball wheel 32 to wind up and unwind the hanging 2.

The two moving units 10 and 11 include transmission elements 22 and 23. The winding roll brackets 4 and 5 are arranged on middle portions of the moving units 10 and 11 to be rotatable about corresponding supports 20 and 21. The two transmission elements 22 and 23 are interconnected by pins 18 and 19 and the square tube 14 in a rotatingly fixed manner. Furthermore, the moving units 10 and 11 include dancer arms 34, 35 being connected to the transmission elements 22 and 23 in a rotatingly fixed manner. The dancer arms 34, 35 each include a bolt support 36, 37 by which they are pivotally supported on one bolt 38, 39 of the respective intermediate elements 6, 7. Furthermore, FIGS. 3 and 4 illustrate a spring F generally known from the prior art.

The functionality of this exemplary embodiment is as follows: when the hanging 2 is completely wound up on the winding roll 3, the dancer arm 35 of the moving unit 11 contacts the stop 41 of the intermediate elements 7, while the dancer arm 34 of the moving unit 10 contacts 10o the stop 40 of the intermediate elements 6. When the hanging 2 is now unwound from the winding roll 3 by its rotation caused by the ball chain 31, the diameter of the winding roll 3 decreases resulting in a gap being formed between the hanging 2 and the mounting location. Due to this gap, the mounting location is not fully darkened even when the hanging 2 fully covers the mounting location. When the ball chain 31 is now further actuated, the ball element 51 enters the passage opening 33 of the cover 32 and blocks it. When the ball chain 31 is further actuated and the ball wheel 30 is turned, the ball wheel 30 together with the ball element 51 lifts up the resilient leg 44. This results in the protrusion 45 of the cover 32 no longer engaging the counter stop 46 of the intermediate element 7 and thus blockage of the moving units 10 and 11 being canceled. Now, when further actuating the ball chain 31, it is possible to pivot the dancer arm 35 of the moving unit 11 towards the stop 43. Since the two moving units 10 and 11 are interconnected in a rotatingly fixed manner by the square tube 14, the dancer arm 34 of the moving unit 10 which contacts the stop 40 of the wall bracket 6 is now also pivoted towards the stop 42. Due to this pivotal movement, the gap between the hanging 2 and the mounting location which resulted from unwinding of the hanging 2 is now closed. Thus, effective and full darkening of the window and of the door, respectively, is achieved without the hanging 2 getting in contact with other items during unrolling.

When it is now intended to stop darkening of the mounting location, one proceeds in the opposite order. The ball chain 31 is actuated as usual for winding up the hanging 2 on the winding roll 3. The dancer arms 34 and 35 of the moving units 10 and 11 pivot back towards the stops 40 and 41. The gap is again formed between the hanging 2 and the mounting location until the dancer arms 34 and 35 contact the stops 40 and 41 and do no longer move. When further actuating the ball chain 31, the ball element 51 is again released from the passage opening 33 of the cover 32 and the hanging 2 is wound up on the winding roll 3 as usual.

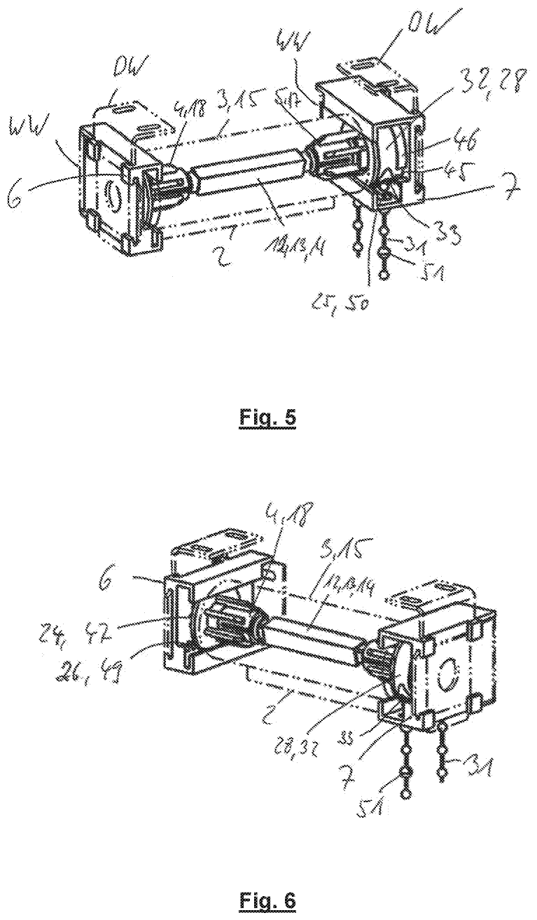

FIGS. 5 and 6 illustrate different perspectives of a second exemplary embodiment of the new winding apparatus 1. A winding roll 3 carrying a hanging 2 as well as different wall brackets WW and ceiling brackets DW are only schematically illustrated. Intermediate elements 6 and 7 can be arranged at the wall brackets WW and the ceiling brackets DW to enable the winding apparatus 1 to be connected to a non-illustrated mounting location.

These illustrations do not show all details of the new mechanism. However, it is to be seen that winding roll brackets 4 and 5 are arranged at the intermediate elements 6 and 7. The winding roll brackets 4 and 5 are designed as hollow pins 16 and 17 at which the winding roll 3 being designed as a hollow roll 15 is located in a rotatingly fixed manner. The winding roll brackets 4 and 5 are supported on transmission elements 22 and 23 in a rotatingly fixed manner. The transmission elements 22 and 23 are interconnected in a rotatingly fixed manner by a torque transmission element 12 being designed as a tube 13 and a square tube 14, respectively.

Furthermore, a counter element 26 being designed as a gear rack 49 is to be seen in FIG. 6, the gear rack 49 engaging the element 24 being designed as a gear wheel 47.

FIG. 2 illustrates a blocking element 28 being designed as a cover 32 for a ball wheel 30 which is not visible. The cover 32 includes passage openings 33 through which an actuator 9, which is designed as a ball chain 31, for a drive element being designed as the ball wheel 30 can be moved. A ball element 51 is arranged on the ball chain 31, the ball element 51 being bigger than the other balls of the ball chain 31 and not being able to pass the passage opening 33. The cover 32 includes a resilient leg 44 which is not visible and at which a protrusion 45 is arranged, the protrusion 45 cooperating with a counter protrusion 46 of the intermediate elements.

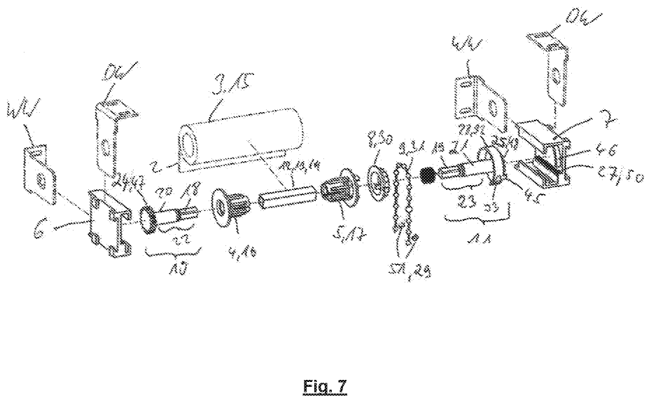

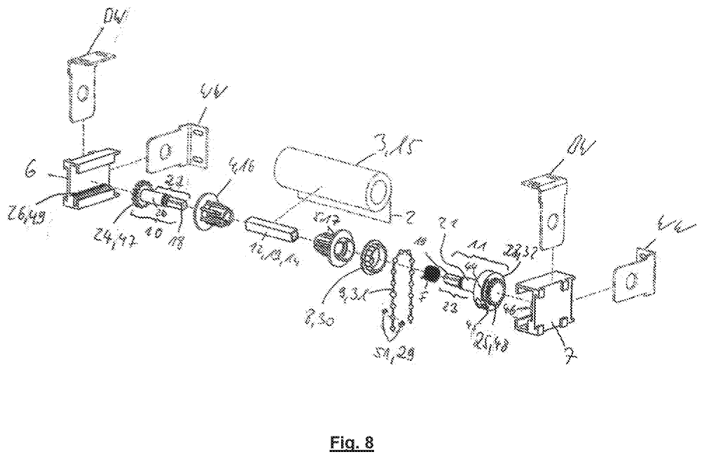

FIGS. 7 and 8 illustrate two different exploded views of the winding apparatus 1 of FIGS. 5 and 6 from which the functionality of the exemplary embodiment can be understood. Two moving units 10 and 11 are well recognizable. The function of moving the winding roll 3 towards a mounting location or away from the mounting location is integrated in the moving units 10 and 11. The winding roll 3 is arranged on the winding roll brackets 4 and 5 being designed as hollow pins 16 and 17 in a rotatingly fixed manner. A ball wheel 30 is arranged on the winding roll bracket 5 in a rotatingly fixed manner such that the winding roll 3 can be rotated by a ball chain 31 cooperating with the ball wheel 32 to wind up and unwind the hanging 2.

The two moving units 10 and 11 include transmission elements 22 and 23. The winding roll brackets 4 and 5 are arranged on middle portions of the moving units 10 and 11 to be rotatable about corresponding supports 20 and 21. The two transmission elements 22 and 23 are interconnected by pins 18 and 19 and the square tube 14 in a rotatingly fixed manner. Furthermore, the moving units 10 and 11 include the elements 24 and 25 being designed as gear wheels 47 and 48 being connected to the transmission elements 22 and 23 in a rotatingly fixed manner. The gear wheels 47 and 48 each engage a gear rack 49 and 50 such that the moving units 10 and 11 including the winding roll 3, the winding roll brackets 4 and 5 as well as the hanging 2 are movable towards the mounting location or away from it. Furthermore, FIGS. 5 and 6 illustrate a spring F known from the prior art.

The functionality of this exemplary embodiment is as follows: when the hanging 2 is completely wound up on the winding roll 3, the gear wheel 48 of the moving unit 11 contacts the end of the gear rack 50 facing away from the mounting location, while the gear wheel 47 of the moving unit 10 contacts the end of the gear rack 49 facing away from the mounting location. When the hanging 2 is now unwound from the winding roll 3 by its rotation caused by the ball chain 31, a gap is formed between the hanging 2 and the mounting location. Due to this gap, the mounting location is not fully darkened even when the hanging 2 fully covers the mounting location. When the ball chain 31 is now further actuated, the ball element 51 enters the passage opening 33 of the cover 32 and blocks it. When the ball chain 31 is further actuated and the ball wheel 30 is turned, the ball wheel 30 together with the ball element 51 lifts up the resilient leg 44. This results in the protrusion 45 of the cover 32 no longer engaging the counter stop 46 of the intermediate element 7 and thus blockage of the moving units 10 and 11 being canceled. Now, when further actuating the ball chain 31, it is possible for the gear wheel 48 to mesh with the gear rack 50. Since the two moving units 10 and 11 are interconnected in a rotatingly fixed manner by the square tube 14, the gear wheel 47 also meshes with the gear rack 49. Due to this meshing of the gear wheels 47 and 48 with the gear racks 49 and 50, the gap between the hanging 2 and the mounting location which resulted from unwinding of the hanging 2 is now closed. Thus, effective and full darkening of the mounting location is achieved without the hanging 2 getting in contact with other items during unrolling.

When it is now intended to stop darkening of the mounting location, one proceeds in the opposite order. The ball chain 31 is actuated as usual for winding up the hanging 2 on the winding roll 3. The moving units 10 and 11 again move away from the mounting location such that the gap is again formed between the hanging 2 and the mounting location until the gear wheels 47 and 48 again reach the other end of the gear racks 49 and 50 and do no longer move. When further actuating the ball chain 31, the ball element 51 is again released from the passage opening 33 of the cover 32 and the hanging 2 is wound up on the winding roll 3 as usual.

Many variations and modifications may be made to the preferred embodiments of the invention without departing substantially from the spirit and principles of the invention. All such modifications and variations are intended to be included herein within the scope of the present invention, as defined by the following claims.

We claim:

1. A winding apparatus for roller blinds, comprising:
a left winding roll bracket;
a right winding roll bracket;
a winding roll, the winding roll supporting a hanging such that it is windable on and unwindable from the winding roll, the winding roll being arranged between the left winding roll bracket and the right winding roll bracket and being connected to the left winding roll bracket and the right winding roll bracket to be commonly rotated with the left winding roll bracket and the right winding roll;
an actuator;
a drive element, the drive element being connected to one of the winding roll brackets to be commonly rotated with the left winding roll bracket and the right winding roll, the drive element being designed and arranged to be driven by the actuator such that the winding roll is rotated and the hanging is wound up on and unwound from the winding roll;
a plurality of intermediate elements; and
a plurality of moving units, the moving units being arranged between the left winding roll bracket and the right winding roll bracket and being connected to the intermediate elements,
the moving units being designed and arranged to support the winding roll, and
the moving units being designed and arranged to move the winding roll, the left winding roll bracket, the right winding roll bracket and the hanging between a rotational position and a holding position due to an actuation of the actuator.

2. The apparatus of claim 1, wherein the actuator is designed as a two-step-actuator including
a first step position in which actuation of the actuator causes winding up and unwinding of the hanging, the first step position being associated with the rotational position, and
a second step position in which actuation of the actuator causes the moving units to be moved, the second step position being associated with the holding position.

3. The apparatus of claim 2, wherein the apparatus is designed and arranged to be mounted at a mounting location, wherein
in the first step position, there is a gap between the hanging and the mounting location,
in the second step position, actuation of the actuator in a first sense of direction causes the gap between the hanging and the mounting location to be decreased and actuation of the actuator in an opposite second sense of direction causes the gap between the hanging and the mounting location to be increased.

4. The apparatus of claim 3, wherein the mounting location is selected from the group consisting of a door, a window, a door frame, a window frame and a wall.

5. The apparatus of claim 1, wherein the moving units are designed and arranged to move the winding roll, the left winding roll bracket, the right winding roll bracket and the hanging between the rotational position and the holding position when the hanging is in an unwound position.

6. The apparatus of claim 1, wherein the actuator is designed as a ball chain and the drive element is designed as a ball wheel.

7. The apparatus of claim 1, wherein the winding roll brackets are rotatably supported in the moving units.

8. The apparatus of claim 1, further comprising a plurality of wall brackets, the moving units being arranged between the winding roll brackets and the wall brackets.

9. The apparatus of claim 1, wherein the moving units are interconnected by a torque transmission element in a rotatingly fixed manner, the torque transmission element being designed as a rod or as a tube extending through the winding roll and the winding roll brackets being designed as hollow pins.

10. The apparatus of claim 1, wherein in the moving units move the winding roll into the respective position by rolling, sliding, swinging or rocking.

11. The apparatus of claim 9, wherein the moving units include transmission elements which
a) at one of their ends include a pin connecting the moving units to the torque transmission element in a rotatingly fixed manner,
b) in their middle portion include supports for the winding roll brackets, the winding roll brackets being rotatably supported on the supports, and
c) at their other end include elements for realizing the movement of the winding roll including the winding roll brackets and the hanging from the rotational position into the holding position, the elements cooperating with counter elements being arranged at the intermediate elements.

12. The apparatus of claim 1, wherein the moving units are made of a rocker which supports the winding roll and which is moved by the actuator in one of the intermediate elements, the torque transmission element being arranged outside of the winding roll.

13. The apparatus of claim 11, wherein the drive element cooperates with a blocking element being arranged on the transmission element such that
a locking element being arranged on the actuator blocks rotation of the winding roll when the blocking element is reached, and
when the actuator is further actuated, transfer of the winding roll including the winding roll brackets and the hanging from a rotational position into an effective and holding position is caused by the moving units.

14. The apparatus of claim 13, wherein the drive element is designed as a ball wheel and the actuator is designed as a ball chain,
the blocking element being designed as a cover for the ball wheel, the cover including a passage opening for the balls of the ball chain, and
the locking element being designed as a ball element including two shells that are clipped together, the locking element being arrangeable on one of the balls of the ball chain and having a diameter being greater than the one of the balls of the ball chain.

15. The apparatus of claim 14, wherein the cover includes a resilient leg and a protrusion facing towards the intermediate element, the protrusion engaging into a counter protrusion of the intermediate elements in a way that, when the hanging is wound up and unwound by the actuator, an actuation of the moving units is stopped and blocked, respectively, while the ball element including two shells and being arranged on the ball chain, when it reaches the passage opening for the balls of the ball chain and when the ball chain is further actuated, cancels this prevention and blockage, respectively, of the moving units since the spring-biased leg is loaded and the protrusion gets free from engagement with the counter protrusion thereby.

16. The apparatus of claim 15, wherein the counter protrusion of the intermediate element is also designed to be resilient.

17. The apparatus of claim 15, wherein the resilient blocking elements and the counter elements are designed as one piece.

18. The apparatus of claim 15, wherein the blocking elements and the counter elements are fully or partly made of resilient metal.

19. The apparatus of claim 11, wherein the elements are designed as dancer arms and include supports for the counter elements of the intermediate elements on which they are pivotally supported between a first stop and a second stop of the intermediate elements, the supports of the dancer arms being preferably designed as bolt supports and the counter elements being preferably designed as bolts.

20. The apparatus of claim 11, wherein the elements are designed as gear wheels and as pitch circle gear wheels, respectively, and cooperate with counter elements of the intermediate elements being designed as gear racks on which they are movable between two end positions.
